(19) United States
(12) Patent Application Publication
(10) Pub. No.: US 2008/0301743 A1
(43) Pub. Date: Dec. 4, 2008

(54) Access to Associated Content

(75) Inventors: Koen H.J. Vrielink, Eindhoven (NL); Gerard Hollemans, Eindhoven (NL); Bartel M. Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,268

(22) PCT Filed: Jul. 21, 2005
(86) PCT No.: PCT/IB2005/052444

§ 371 Date: Jan. 18, 2007

(30) Foreign Application Priority Data
Jul. 22, 2004 (GB) 0416342.4

(51) Int. Cl. H04N 7/173

(52) U.S. Cl. 725/110

(57) ABSTRACT

A network (10) of media processing devices includes a serving device (30) which receives primary media content and at least one rendering device (50, 70). The serving device (30) provides a service to other devices in the network by storing information about which primary content streams have secondary content associated with them and responds to requests from other devices in the network for the stored information. Devices (e.g. Control Point CP 20) can request the information as part of a process of establishing a connection between the serving device (30) and a rendering device (50) in the network for the delivery of the primary content. Alternatively, devices can register an interest in being notified when secondary content becomes available. A user can select whether they wish to accept the secondary content and can determine which device (50, 70) renders the secondary content.

This invention relates to accessing content within a network.

Broadcast content often includes additional materials alongside the primary content which can enhance the viewer's experience of the primary content. As an example, a television broadcast of a sports programme may carry additional content in the form of a page of interesting statistics about players. The additional content, which will be called secondary or associated content, can be carried as part of the broadcast stream or a link, such as a Uniform Resource Locator (URL), can be carried by the broadcast stream which points to a server which stores the associated content. Associated content can then be retrieved from the server using the URL.

The above works well enough when the broadcast stream is sent directly to a receiving terminal, such as a television set, and where the receiving terminal is in control of the presentation of the associated material. However, there is an increasing desire to network consumer devices within a home or local environment. When a broadcast stream enters a home in which a network exists, the broadcast stream may not be transported directly to the rendering device (e.g. TV set). Instead the broadcast stream is often transported to a server where other content may also reside on a storage device. The server will often perform some processing of the broadcast stream before delivering the stream to the rendering device via the in-home digital network. In this networked situation the stream that is sent to the rendering device must comply with some content interoperability standard and this standard may not support the associated content, or the link to the associated content, causing it to be removed. Even if the in-home network stream to the rendering device does preserve the associated content, the rendering device may not be the device to which a user wishes the associated content to be delivered.

The present invention seeks to provide an alternative way of managing access to associated content within a networked environment.

Accordingly, a first aspect of the present invention provides a method of operating a media content serving device which can form part of a network of devices, the method comprising:

receiving a primary stream of media content from a content source;

determining if there is secondary content associated with the primary stream of media content; and,

providing a service for other devices in the network by storing information about which primary content streams have secondary content associated with them and responding to requests from other devices in the network for the stored information.

Storing information in this manner allows another device in the network, such as a control device, to determine when secondary content is available, even if the content is removed from the primary content during processing/delivery to a rendering device within the network. It also allows another device, which may not be part of the normal delivery chain of the primary content, to discover the availability of secondary content and to establish a connection for the delivery of the secondary content to a rendering device. The delivery chain is the path taken by the primary content between devices within the home network.

The term secondary content is intended to include actual content, or a link such as a URL/URI which points to a location where the secondary content is stored.

A further aspect of the invention provides a method of operating a control device which can form part of a network of media processing devices, the network including a serving device which receives primary media content and at least one rendering device, the method comprising:

determining if there is secondary content associated with the primary content by using information obtained from the serving device; and,

establishing a connection between the serving device and a rendering device in the network for the delivery of the secondary content.

The control device can also be used to establish a connection between a serving device and a rendering device for the delivery of primary content, or it can be a separate control device which is not part of the delivery chain of the primary content.

Preferably, the control device hosts, or is connected to, a user interface which a user can use to select whether they wish to accept the secondary content and to specify on which device they wish to have the secondary content rendered.

The control device can determine the availability of secondary content during a process of establishing a connection between devices for the delivery of primary content, or it can register an interest in being notified of the availability of secondary content.

The functionality described here can be implemented in software, hardware or a combination of these. The invention can be implemented by means of hardware comprising several distinct elements, and by means of a suitably programmed computer. Accordingly, another aspect of the invention provides instructions for causing a processor to perform the above methods.

It will be appreciated that software may be installed on the host apparatus at any point during the life of the equipment. The software may be stored on an electronic memory device, hard disk, optical disk or other machine-readable storage medium. The software may be delivered as a computer program product on a machine-readable carrier or it may be downloaded directly to the host apparatus via a network connection.

Further aspects of the invention provide a media serving device and a control device which perform the methods.

The invention can be implemented as part of a Universal Plug and Play network but the invention is not limited to such a network.

Embodiments of the present invention will now be described, by way of example only, with reference to the accompanying drawings, in which:

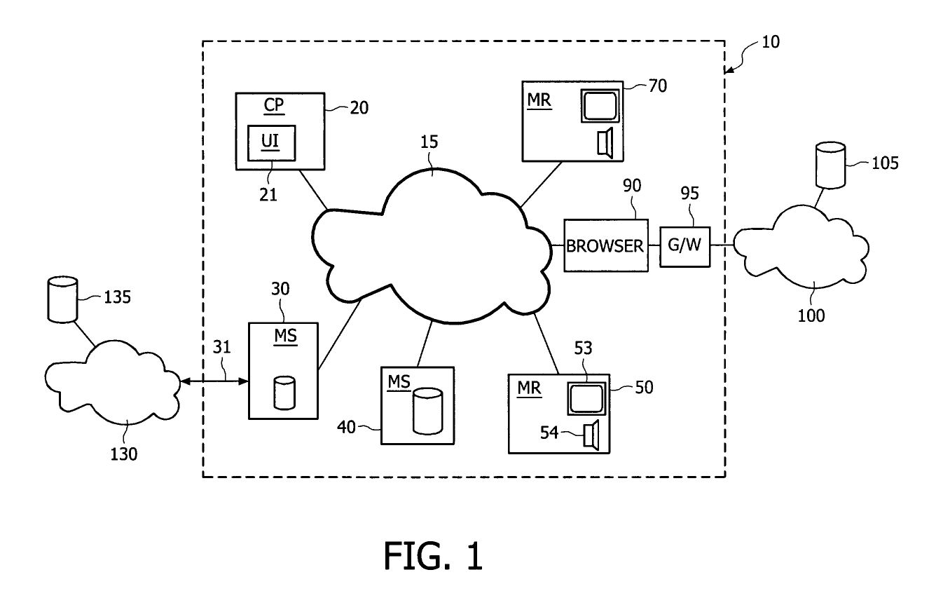

FIG. 1 shows an example network of multimedia devices to which the invention can be applied;

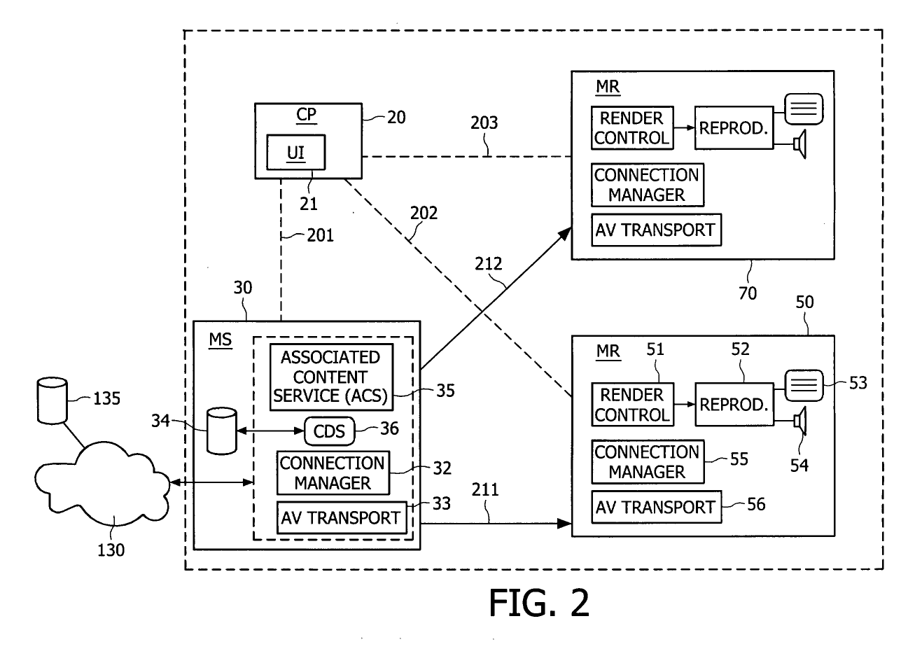

FIG. 2 shows a first embodiment of the invention;

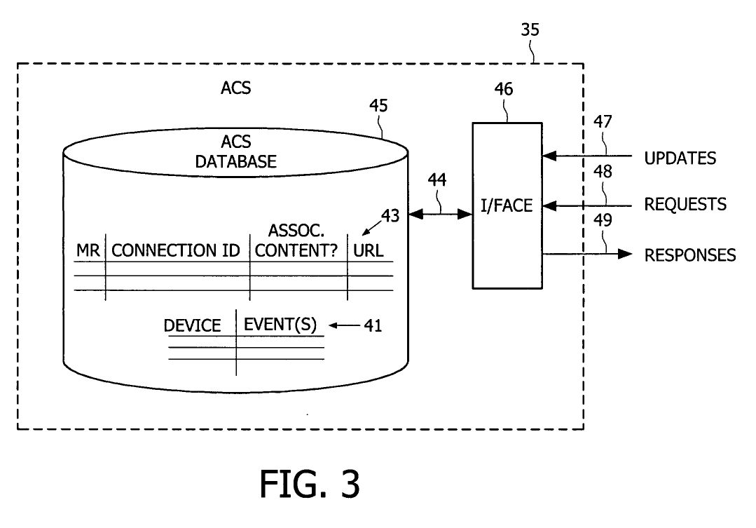

FIG. 3 shows the Media Server of FIG. 2 in more detail;

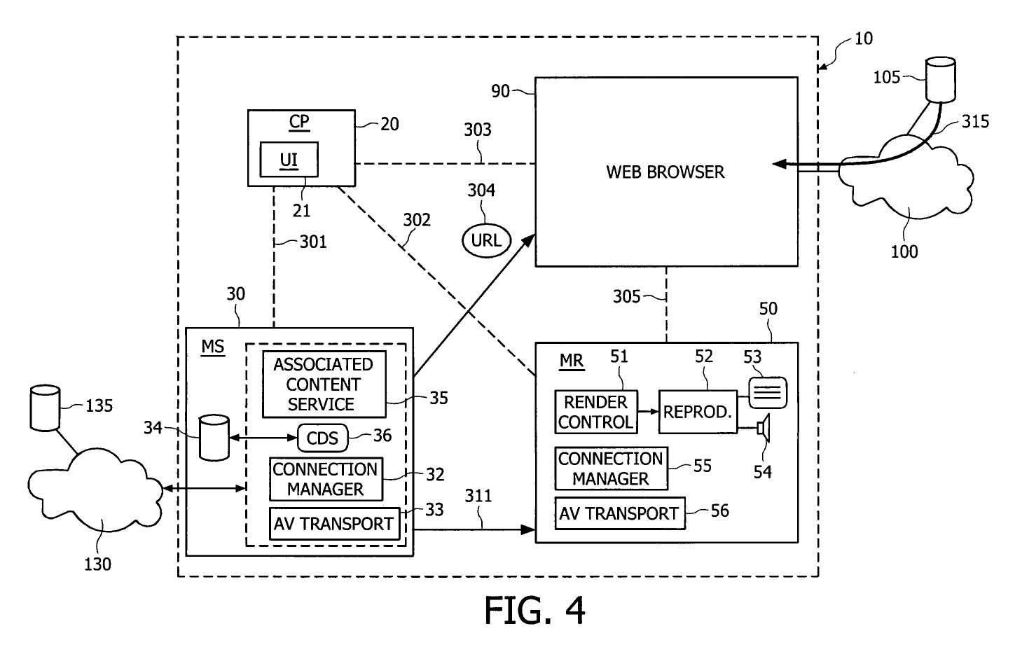

FIG. 4 shows a second embodiment of the invention; and,

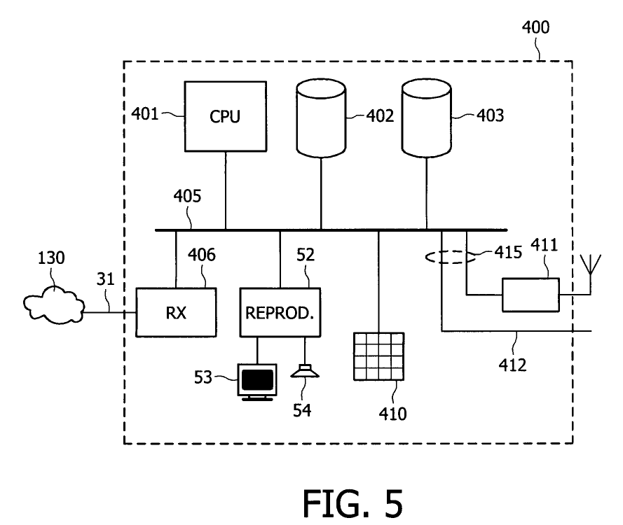

FIG. 5 shows a hardware implementation of one of the devices of the network.

FIG. 1 shows an example network 10 of multimedia devices which can exist, for example, within a home. The devices are shown connected together by a shared medium 15. The connection between the devices can be a wired connection, using a wired local area networking (LAN) protocol, or a wireless local or personal area networking technology such as IEEE 802.11, HiperLAN/2 or Bluetooth™. The following description of a preferred embodiment is based on Universal Plug and Play (UPnP) although the invention is not limited to use of the UPnP protocol and architecture. Universal Plug and Play (UPnP) is a communications protocol which allows electronic devices produced by different manufacturers to operate with one another. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point. Information about the UPnP architecture can be obtained from http://www.upnp.org.

The network of FIG. 1 includes a Media Server device MS 30 which receives broadcast content such as television and radio channels via a broadcast channel. The broadcast content originates from a source 135 and is transmitted via a transmission network 130, such as a Digital Video Broadcasting-Satellite (DVB-S) or Digital Video Broadcasting-Terrestrial (DVB-T) transmission network. Media Server 30 receives 31 the content, processes the content and makes the content available to other devices in the home network 10. The broadcast content comprises a primary stream of data, such as video and audio data for a television programme, and secondary or ‘associated’ content. In the case of analogue broadcasts, the associated content (or the link to it) can be sent in the vertical blanking interval (VBI), whereas for digital broadcasts the associated content (or the link to it) can be embedded in metadata frames of the transport stream. The combined primary and associated content can be carried across network 130 in an MPEG-2 transport stream, whereas it may be transported from MS 30 to the Media Renderer MR 50 as an MPEG-2 elementary stream or even via HTTP-transport of an AVI-file. Alternatively, the content can be transcoded from MPEG-2 to MPEG-4 at MS 30. This can have the effect of removing the associated content from the primary data stream. Examples of the associated content are:

data carrying background information about the TV programme, e.g. interesting statistics during a sports programme, information about an advertised product, lyrics and album art during a radio broadcast;

a URL from where a user can obtain more information or make an online purchase, e.g. a URL to the broadcaster or programme provider's web site, or the online shop of a retailer stocking a product advertised during a commercial;

further video and/or audio data (e.g. alternative camera angles during a sports programme or a concert).

The network 10 can include further Media Server devices MS 40 which may locally store content such as audio tracks, video clips, movies and digital images. Media Rendering devices MR 50, 70 render the broadcast content, or locally stored items of content, for presentation to a user. A web browser 90 connects to an external network 100, such as the internet, via a gateway device 95 such as a digital subscriber line (DSL) modem. The browser 90 can retrieve data from a remote store 105. A user interface (remote control) 21 is provided as part of a Control Point 20 and allows a user to view information about content stored locally within network 10 or broadcast content received at MS 30. The User interface 21/Control Point 20 also allow a user to select an item of content and to select which device 50, 70 within the network 10 renders that item (or stream) of content. The user interface 21 can be a simple keypad or it can be a more complex device such as a touch-sensitive screen which may be combined with a display. The Control Point 20 supports the conventional UPnP mechanisms for discovering new devices in the network 10 and also supports mechanisms for finding the capabilities of Media Rendering devices 50, 70 and establishing connections between a Media Server 30 and a Media Renderer 50, 70. The UPnP AV Architecture supports a wide variety of AV devices and different types of formats for the content.

Although the Media Server devices 30, 40, Media Renderer devices 50, 70 and Control Point device 20 are shown as separate entities, two or more of these may be combined in a single physical device in a manner which will be well understood.

FIG. 2 shows one way in which the network of FIG. 1 can be operated to access the primary and associated content. FIG. 2 also shows the main functional units of the Media Server 30 and Media Renderer 50. Media Server MS 30 supports a Content Directory Service (CDS) 36 which maintains a directory of content stored in store 34. Broadcast streams appear as content item entries in the CDS, just as other stored content would be.

Further functions of the Media Server 30 are a Connection Manager Service 32 which is used to manage connections between the Media Server 30 and other devices, such as the Media Renderers 50, 70. An optional AV Transport Service 33 allows control of the playback of content, with features such as stop, pause, seek etc. These are all known functions of a UPnP Media Server device and need not be described any further.

A first Media Renderer MR 50 renders (reproduces) media content which is received from the Media Server 30. Reproduction equipment 52 is shown with a display 53 and speaker 54 although the output can take many forms. Typically, the reproduction equipment 52 includes one or more decoders for decoding the media content (such as an MP3 audio decoder and MPEG2 video decoder) along with output stages such as amplification and speakers 54 for providing an audio output and a display 53 for presenting a visual output, digital to analog converter and amplifiers. The Media Renderer MR 50 also supports a Connection Manager Service 55 for establishing a new connection with a Media Server, a Render Control 51 for controlling the way in which the content is rendered and an optional AV Transport Service 56. For audio reproduction this can include features such as a volume control. A second media Renderer MR 70 is also shown, which includes the same functional units as Media Renderer 50, although it need not be identical to Media Renderer 50, e.g. it may only provide a visual output.

In FIG. 2 a Control Point 20 sets up a connection for a primary content stream. This is achieved by a signalling flow 201 between CP 20 and MS 30 and a signalling flow 202 between CP 20 and MR 50 and results in a stream of the primary content data being delivered 211 from MS 30 to MR 50. The primary content data is rendered for presentation to a user, by MR 50, in the normal manner.

The Media Server MS 30 hosts an additional (UPnP) service, which will be called the Associated Content Service (ACS) 35, which allows any other network device to access the associated content, or the link to the associated content. One way of providing this service is to store a table containing the identifier of the Media Renderer (MR) of the primary content, a stream/connection ID, a flag indicating the presence of associated content, the link to the associated content and any other beneficial information.

While establishing the connection between MS 30 and MR 50, the Control Point CP 20 will find the Associated Content Service (ACS) supported by MS 30 using a normal UPnP discovery process. Devices (e.g. MS 30) broadcast a UDP message and announce their presence on the network. Other devices (e.g. CP 20) receive this message and use the information contained therein to contact a device (MS 30) and request the services offered via standardised UPnP interfaces. The Control point CP 20 checks if associated content exists. For this the ACS 35 will support a function such as:

getAssociatedContent(ConnectionID)

In this example the ConnectionID is used to identify the primary content for which associated content is requested. Alternatively, the identifier of the renderer where the primary stream (which will be called the primary renderer) can be supplied by the Control Point 20. This function may return nothing, if no associated content exists, or one or more URLs or URIs which point to the associated content.

If the associated material is delivered via the same broadcast channel as the primary content then the associated material will be exposed as an additional content item within the Content Directory Service CDS 36 on the Media Server 30 and the link that is retrieved from the Associated Content Service 35 will point to this content. As shown in FIG. 3, if the associated content must be retrieved from an external source, then the link retrieved from the Associated Content Service 35 will be a URL pointing to the associated content and standard internet mechanisms can be used to retrieve (and render) the content.

When the CP 20 determines that associated content exists, it can feed this information back to the user, using user interface 21. This allows a user to specify whether they want to access the associated content and also to ask the user where they want the associated content rendered. After this, the CP can establish a connection for the associated content stream 212 between the Media Server 30 and a second (e.g. user selected) Media Renderer 70 to render the associated content, using the information (links) retrieved from the ACS and existing UPnP-AV mechanisms, such as signalling 203.

FIG. 3 shows the Associated Content Service (ACS) 35 supported by the Media Server MS 30. A database 45 stores a table 43 as described above, which includes a connection ID, an identifier of the Media Rendering MR device which renders the primary content, an indication of whether there is currently associated content associated with the primary content, and a URL/URI (if one exists) to the associated content. The database 45 is accessed 44 via an interface 46 which receives updates 47, such as new incoming streams of data to the Media Server 30 and information about the existence of associated content. The URL may be updated a number of times during the course of a stream of primary content, such as when different commercials are being carried by the primary stream of video/audio data representing a television channel. Requests 48 are received from devices within the network 10 and responses 49, which include information obtained from database 45, are provided to the devices. In addition, and as described more fully below with reference to FIG. 4, the database 45 can also store a list 41 of devices that have registered with it, and information about the event(s) the devices wish to be notified of. Devices send a registration request which includes information about the event they wish to be notified of; this may include the identity of a rendering device 50, 70 which the device wishes to render associated content for. When an event occurs which matches the registered event information, the registered device is notified 49.

The above description assumes that the existence of associated content is known at the time of establishing a connection for the delivery of primary content. It is possible that associated content is only sent on an occasional basis, after a connection for primary content has already been established between a Media Server and Media Renderer. There are two ways of handling associated content under these circumstances. Firstly, a connection for the delivery of associated content can be set-up immediately after the connection for the delivery of primary content. In this case, the associated content is delivered as it becomes available according to the predefined connection. Secondly, devices within the network can become clients of the Associated Content Service ACS and subscribe to events that signal the arrival of secondary content. This allows a client (e.g. CP 20) to set-up a connection for associated content when it becomes available.

FIG. 4 shows a further embodiment of the invention, which is applicable where the associated content is a URL which points to content which must be retrieved by a web browser 90. A Control Point 20, Media Server MS 30, Media Renderer 50 and a web browser 90 are shown. As in FIG. 2, a Control Point 20 sets up a connection for a primary content stream. This is achieved by a signalling flow 301 between CP 20 and MS 30 and a signalling flow 302 between CP 20 and MR 50 and results in a stream of the primary content data being delivered 311 from MS 30 to MR 50. The primary content data is rendered for presentation to a user in the normal manner. In the same manner as before, Control Point 20 can determine whether associated content is available at the time of establishing 301 the connection 311 for the primary content. If associated content is available, this can be signalled to the web browser 90, either by sending a message 303 from the CP 20 to the web browser 90 with the URL pointing to associated content, or by causing MS 30 to send a message 304 to the web browser 90 with the URL. In response to receiving the URL, the web browser 90 retrieves 315 content from the external store 105, via network 100. The URL may point to a home page of the broadcaster or programme provider, an online store, or a specific page of information relevant to what is being carried by the primary content stream 311.

In an alternative arrangement, the Control Point 20 does not control the distribution of the associated content (or a URL which points to it). Instead, web browser 90 ‘monitors’ the ACS 35 supported by Media Server MS 30 and pro-actively offers to render whatever associated content is available to support primary content on a certain Media Renderer within the network 10. As an example, web browser 90 could offer to render any associated content for MR 50. The browser device 90 can use standard UPnP discovery mechanisms to discover the Media Renderer MR 50 and Media Server MS 30 (e.g. signalling 305) and can use the Associated Content Service (ACS) on the MS 30 to retrieve the URL of the associated content. This can be achieved by making a call to the ACS of MS 30 such as:

getAssociatedContent(DeviceID)

where ‘DeviceID’ is the identifier of the rendering device (MR 50). Alternatively, the web browser 90 can subscribe to the event that associated content is becoming available. The ACS at MS 30 maintains a list of interested devices, details of the event(s) they are interested in being notified of and issues messages to all subscribed devices when their events occur. An identifier of web browser 90 is stored within list 41 (FIG. 3), with the subscribed event being the availability of associated content for rendering device 50. In the example given above, the ACS will issue a message to web browser 90 when associated content becomes available that is associated with the primary content delivered to MR 50.

The ‘monitoring’ device can also act as a Control Point CP and set-up streams to a Media Rendering (or web browsing function) that is collocated with the monitoring device or separate from it. In such a system there will be two devices each implementing Control Point functionality with, for example, a first CP 20 setting up a connection for a stream of primary content between MS 30 and MR 50 and a second CP setting up a connection between MS 30 and a further Media Rendering device (MR 70) or a web browser 90.

It is not essential that the associated content is rendered by a separate physical device to the primary renderer, and both the primary and associated content could be rendered by the same device, such as by a picture within a picture on a common display.

In the above embodiments of the invention the primary renderer 50 does not need to know about the existence of the associated content and so the removal of associated content at MS 30 does not affect the ability of the network to establish a connection between network devices for the rendering of the associated content.

It will be appreciated that the broadcast content is not limited to content carried via a terrestrial or satellite transmission network, and can also be content which is broadcast or multicast across an IP network such as the Internet. The invention can be applied to broadcast content which has been stored (e.g. by a Media Server device 30, 40 within the network) for later replay and to content which has not originated from a broadcast source, such as content which is distributed via a Digital Versatile Disc (DVD).

The Control Point 20, Media Server 30, and Media Rendering devices 50, 70 can be implemented on a variety of processing platforms, such as a general purpose PC or a dedicated processing unit. FIG. 5 shows a hardware implementation of a platform 400 for hosting one or more of the above devices. A central processing unit 401 executes software, as previously described, to support the functions and method described. Non-volatile memory 402 and volatile memory 403 store the operating software used by the processing unit 401. For the Media Server 30, a receiver front-end 406 connects to a network 130. Control messages and primary/associated content are carried between devices by local network connections 415, which can use wired 412 and/or wireless 411 technologies. Appropriate hardware may be provided to support the particular local network such as a local area network card and a wireless modem. User inputs can be provided directly to the platform by input devices 410 such as a keypad, keyboard, mouse or tablet. Alternatively, user inputs may be received from a user interface that is locally networked with the platform. An output may be directly presented to a user via reproduction equipment 52, such as a display driver and audio card, to display 53 and loudspeaker 54. A bus 405, or combination of buses of different types, connect the above units.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim. Where the system/device/apparatus claims recite several means, several of these means can be embodied by one and the same item of hardware.

In the description above, and with reference to the Figures, there is described a network 10 of media processing devices includes a serving device 30 which receives primary media content and at least one rendering device 50, 70. The serving device 30 provides a service to other devices in the network by storing information about which primary content streams have secondary content associated with them and responds to requests from other devices in the network for the stored information. Devices (e.g. Control Point CP 20) can request the information as part of a process of establishing a connection between the serving device 30 and a rendering device 50 in the network for the delivery of the primary content. Alternatively, devices can register an interest in being notified when secondary content becomes available. A user can select whether they wish to accept the secondary content and can determine which device 50, 70 renders the secondary content.

1. A method of operating a media content serving device which can form part of a network (10) of devices, the method comprising:
receiving a primary stream of media content from a content source (135);
determining if there is secondary content associated with the primary stream of media content; and,
providing a service for other devices (20) in the network by storing information (43) about which primary content streams have secondary content associated with them and responding to requests (48) from other devices in the network for the stored information (43).

2. A method according to claim 1 further comprising:
receiving a registration request from a device within the network that wishes to be notified of the availability of secondary content;
maintaining a list (41) of registered devices; and,
notifying the registered devices when secondary content becomes available.

3. A method according to claim 2 wherein the registration request identifies a device within the network to which primary content is being delivered.

4. A method according to claim 3 wherein the registered devices are only notified if there is secondary content associated with primary content being delivered to the device identified in the registration request.

5. A method according to claim 1 further comprising:
receiving a request from a control device (20) within the network to establish a connection between the serving device and a rendering device in the network for the delivery of the primary media content; and,
notifying the control device (20) that there is secondary content associated with the primary content.

6. A method according to claim 1 further comprising establishing a connection to a device within the network for delivering the secondary content.

7. A method according to claim 6 wherein the step of establishing a connection includes receiving an identifier of the device to which the secondary content is to be delivered.

8. A method according to claim 6 wherein the secondary content is delivered to a different device to that which the primary content is delivered.

9. A method of operating a control device which can form part of a network of media processing devices, the network including a serving device (30) which receives primary media content and at least one rendering device (50, 70), the method comprising:
determining if there is secondary content associated with the primary content by using information obtained from the serving device (30); and,
establishing a connection between the serving device (30) and a rendering device (70) in the network for the delivery of the secondary content.

10. A method according to claim 9 further comprising determining an identifier of the rendering device to which the secondary content is to be delivered.

11. A method according to claim 10 wherein the identifier of the rendering device is received from a user interface (21).

12. A method according to claim 11 further comprising sending a list of possible rendering devices to the user interface (21), for selection by a user.

13. A method according to claim 9 further comprising sending a registration request to the serving device (30) to register an interest in secondary content and receiving a notification from the serving device (30) when secondary content is available.

14. A method according to claim 13 wherein the registration request identifies a rendering device (50) for rendering primary content.

15. A method according to claim 9 which is performed as part of a step of establishing a connection between the serving device (30) and a rendering device (50) in the network for the delivery of the primary media content.

16. A method according to claim 1 further comprising a step of determining if a user wishes to accept the secondary content, and wherein the step of establishing a connection is only performed if the user wishes to accept the secondary content.

17. A method according to claim 1 wherein the network (10) is a Universal Plug and Play (UPnP) network.

18. A method according to claim 1 wherein the secondary content is an address which identifies a storage location (105) from which a rendering device can retrieve the secondary content.

19. A method according to claim 1 wherein the primary content is broadcast content.

20. Instructions for causing a processor to perform the method according to claim 1.

21. A computer readable medium bearing the instructions according to claim 20.

22. A media content serving device (30) which can form part of a network (10) of devices, the serving device being operable to:
receive a primary stream of media content from a content source (135);
determine if there is secondary content associated with the primary stream of media content; and,
provide a service for other devices in the network by storing information (43) about which primary content streams have secondary content associated with them and responding to requests (48) from other devices in the network for the stored information (43).

23. A media content serving device (30) which can form part of a network (10) of devices, the serving device being operable to:
receive a primary stream of media content from a content source (135);
determine if there is secondary content associated with the primary stream of media content; and,
provide a service for other devices in the network by storing information (43) about which primary content streams have secondary content associated with them and responding to requests (48) from other devices in the network for the stored information (43) which is further operable to perform the method of claim 2.

24. A control device (20) which can form part of a network (10) of media processing devices, the network including a serving device (30) which receives primary media content and at least one rendering device (50, 70), the control device (20) being operable to:
determine if there is secondary content associated with the primary content by using information obtained from the serving device (30); and,
establish a connection between the serving device (30) and a rendering device (50, 70) in the network for the delivery of the secondary content.

25. A control device (20) which can form part of a network (10) of media processing devices, the network including a serving device (30) which receives primary media content and at least one rendering device (50, 70), the control device (20) being operable to:
determine if there is secondary content associated with the primary content by using information obtained from the serving device (30); and,
establish a connection between the serving device (30) and a rendering device (50, 70) in the network for the delivery of the secondary content which is further operable to perform the method according to claim 10.

26. A network of media processing devices which comprises the media serving device according to claim 22.
